(19) United States
(12) Patent Application Publication
(10) Pub. No.: US 2026/0197926 A1
(43) Pub. Date: Jul. 9, 2026

(54) LED APPARATUS, LED LAMP, LED LIGHT STRING, AND METHOD OF OPERATING THE SAME

(71) Applicant: SEMISILICON TECHNOLOGY CORP., New Taipei City (TW)

(72) Inventor: Wen-Chi PENG, New Taipei City (TW)

(21) Appl. No.: 19/194,493

(22) Filed: Apr. 30, 2025

(30) Foreign Application Priority Data
Jan. 7, 2025 (TW) 114100657

(51) Int. Cl. H05B 47/175; F21S 4/10; F21Y 115/10; H05B 45/325; H05B 47/135; H05B 47/16; H05B 47/165

(52) U.S. Cl. CPC H05B 47/198; F21S 4/10; H05B 45/325; H05B 47/135; H05B 47/16; H05B 47/165; F21Y 2115/10

(57) ABSTRACT

A method of operating a LED light string includes steps of: (a) activating a control device and a plurality of LED apparatuses, (b) sequencing each of the LED apparatuses according to a voltage value generated at difference sequence positions to generate a serial number, (c) providing, by the control device, a plurality of sequence codes to the LED apparatuses, and comparing, by each LED apparatus, its own serial number with the plurality of sequence codes, (d) generating a disturbance signal, by the LED apparatus, when the LED apparatus compares the stored serial number with one of the sequence codes and a comparison result is the same to trigger the control device or the LED apparatus to record the sequence code as the sequence position of the LED lamp, and (e) completing the recording of the sequence codes corresponding to the respective serial numbers of each of the LED lamps.

### BACKGROUND

### Technical Field

The present disclosure relates to a LED apparatus, a LED lamp, a LED light string, and a method of operating the same.

### Description of Related Art

The statements in this section merely provide background information related to the present disclosure and do not necessarily constitute prior art.

Since light-emitting diode (LED) has the advantages of high luminous efficiency, low power consumption, long life span, fast response, high reliability, etc., LEDs have been widely used in lighting fixtures or decorative lighting, such as Christmas tree lighting, lighting effects of sport shoes, etc. by connecting light bars or light strings in series, parallel, or series-parallel.

Take the festive light for example. Basically, a complete LED lamp includes an LED light string having a plurality of LEDs and a drive unit for driving the LEDs. The drive unit is electrically connected to the LED light string, and controls the LEDs by a pixel control manner or a synchronous manner by providing the required power and the control signal having light data to the LEDs, thereby implementing various lighting output effects and changes of the LED lamp.

According to the present technology, in order to drive the LEDs of the LED light string to diversify light emission, the LEDs have different address sequence data. The LEDs receive lighting signals including light data and address data. If the address sequence data of the LEDs are the same as the address data of the lighting signals, the LEDs emit light according to the light data of the lighting signals. If the address sequence data of the LEDs are not the same as the address data of the lighting signals, the LEDs ignore the light data of the lighting signals.

At present, most of the LED sequence methods of the LED light string are complicated and/or difficult. For example, before the LEDs are combined into an LED light string, it is necessary to burn different address sequence data for each LED. Afterward, the LEDs are sequentially arranged and combined into the LED light string according to the address sequence data. If the LEDs are not arranged in sequence according to the address sequence data, the diversified light emission of the LEDs cannot be correctly achieved.

Furthermore, the current RC sequencing method requires the use of previously known light string conditions, such as light distance, wire resistance, etc., and according to these conditions, the pulse width sent by the controller is set in advance. When the finished product is powered on, these different pulse widths are used for sequencing to acquire continuous light codes, such as 1, 2, 3, and so on. However, it still has some inconveniences, such as the need to define the pulse width for a certain product in advance, and different light strings must be redefined.

Therefore, how to design a LED apparatus, a LED lamp, a LED light string, and a method of operating the same to solve the problems and technical bottlenecks in the existing technology has become a critical topic in this field.

### SUMMARY

A first objective of the present disclosure is to provide a method of operating a LED light string. The LED light string includes a control device and a plurality of LED lamps connected with the control device, and each LED lamp comprises a LED apparatus. The method includes steps of: (a) receiving a DC power source, by the LED light string, to activate the control device and each LED apparatus, (b) sequencing each of the LED apparatuses according to a voltage value generated at difference sequence positions in the LED light string to generate a serial number and store the serial number, (c) providing, by the control device, a plurality of sequence codes to the LED apparatuses, and comparing, by each LED apparatus, its own serial number with the plurality of sequence codes, (d) generating a disturbance signal, by the LED apparatus, to the LED light string when the LED apparatus compares the stored serial number with one of the sequence codes and a comparison result is the same to trigger the control device or the LED apparatus to record the sequence code as the sequence position of the LED lamp in the LED light string, and (e) repeatedly performing, by the control device, step (c) and step (d), to acquire the sequence positions of LED apparatuses in the LED light string until the recording of the sequence codes corresponding to the respective serial numbers of each of the LED lamps is completed.

In one embodiment, in step (c) further comprising a step of: counting the number of times the voltage value changes, and in step (d), the control device or the LED apparatus records the number of times the voltage value changes as the sequence code.

In one embodiment, after step (e), the LED apparatus receives a lighting signal having a sequence code and a lighting information or a lighting signal having a lighting information involving a sequence of the sequence code. When the sequence code or the sequence of the sequence code matches the serial number, the LED apparatus performs specific lighting behaviors of the lighting information.

In one embodiment, in step (c), further comprising the control device is configured to provide sequence codes in an incremental manner until at least two instances of a disturbance signal are detected, wherein an increment value is determined based on a difference between the sequence codes respectively corresponding to the first two detected disturbance signals, a new initial value of the sequence codes is generated based on the increment value, and the control device continues to provide the sequence codes based on the new initial value.

In one embodiment, in step (c), further comprising the control device is configured to provide sequence codes in a decremental manner until at least two instances of the disturbance signal are detected, wherein a decrement value is determined based on a difference between the sequence codes respectively corresponding to the first two detected disturbance signals, a new initial value of the sequence codes is generated based on the decrement value, and the control device continues to provide the sequence codes based on the new initial value.

In one embodiment, the lighting signal provided by the control device has a plurality of pulses having a plurality of pulse widths. The control device and the LED apparatus respectively use a pulse width with a single high level or a single low level as a judgment reference of a digital signal.

A second objective of the present disclosure is to provide a LED light string. The LED light string receives a DC power source. The LED light string includes a control device and a plurality of LED lamps. Each LED lamp includes a LED apparatus, and the LED apparatus includes a sequencing circuit and a sorting circuit. The sequencing circuit sequences each LED apparatus according to a voltage value generated at difference sequence positions in the LED light string to generate a serial number and store the serial number. The control device provides a plurality of sequence codes to the LED apparatuses. The sorting circuit compares its own serial number with the plurality of sequence code. When the LED apparatus compares the stored serial number with one of the sequence codes and a comparison result is the same, the LED apparatus generates a disturbance signal to the LED light string to trigger the control device or the LED apparatus to record the sequence code as the sequence position of the LED lamp in the LED light string. Until the recording of the sequence codes corresponding to the respective serial numbers of each of the LED lamp is completed, the sequence positions of LED apparatuses in the LED light string are acquired.

In one embodiment, the LED light string further includes a switch unit and at least one resistor. The switch unit is connected to the DC power source. The at least one resistor is connected to the switch unit. The disturbance signal generated on the resistor triggers the control device or the LED apparatus to record the sequence code as the sequence position of the LED lamp in the LED light string.

In one embodiment, the LED light string further includes a switch unit. The switch unit is connected to the DC power source. The disturbance signal generated on an internal resistance of the switch unit triggers the control device or the LED apparatus to record the sequence code as the sequence position of the LED lamp in the LED light string.

In one embodiment, the sequencing circuit includes a load component, a capacitive component or a switch component, a current load, and a voltage processor. The load component provides a resistance value. The capacitive component or the switch component is connected in series to the load component at a node, and the capacitive component or the switch component generates an inner voltage at the node. The current load is connected in parallel to the load component and the capacitive component or the switch component connected in series, and the current load provides a current path. The voltage processor receives the inner voltage, and compares the inner voltage with a threshold voltage to generate a comparison signal. The sequencing circuit counts time to acquire a time value from a starting time when the voltage processor starts to generate the comparison signal to a time when a level of the comparison signal changes, and the serial number of the LED apparatus is generated according to the time value.

In one embodiment, the sequencing circuit further includes a logic gate and a counter. The logic gate receives the comparison signal and a clock signal, and performs a logic operation on the comparison signal and the clock signal to generate an output signal. The counter receives the output signal. The LED apparatus is supplied power by the DC power source and the inner voltage is gradually changed. When the inner voltage has not reached the threshold voltage, the comparison signal causes the output signal to be the clock signal and the counter counts time. Until the inner voltage reaches the threshold voltage, the comparison signal causes the output signal to stop the counter from counting so as to acquire the time value during the counter counting time.

In one embodiment, the sorting circuit includes a comparator. The comparator receives the sequence codes and the serial number provided by the sequencing circuit, and compare the serial number with the sequence codes.

In one embodiment, each LED apparatus further includes a carrier detector and a current load controller. The carrier detector receives a voltage provided by the DC power source, and when the voltage is detected as a carrier signal voltage, the sorting circuit is activated to operate. The current load controller receives a sequencing signal and a sorting signal. The current load controller activates the current load to sequence according to the sequencing signal, and disables the current load when the sequence is completed. The current load controller activates the current load to draw load according to the sorting signal to generate the disturbance signal.

In one embodiment, the sequencing circuit further counts the number of times the voltage value changes, and the control device or the LED apparatus records the number of times the voltage value changes as the sequence code.

In one embodiment, the control device or the LED apparatus is triggered to record the sequence code as the sequence position of the LED lamp in the LED light string according to the disturbance signal received on a data wire or the disturbance signal received on a resistor.

In one embodiment, each LED apparatus further includes a signal processing unit and a current load controller. The signal processing unit is connected to a data wire, and the signal processing unit includes a signal amplifier and a signal processor. The current load controller receives a sequencing signal and a sorting signal. The current load controller activates the current load to sequence according to the sequencing signal, and disables the current load when the sequence is completed. The current load controller activates the current load to draw load according to the sorting signal to generate the disturbance signal.

In one embodiment, each LED apparatus further includes a signal processing unit. The signal processing unit is connected to a data wire, and the signal processing unit includes a signal amplifier, a signal processor, a switch, and a logic circuit.

In one embodiment, each LED apparatus further includes a signal processing unit and a current source. The signal processing unit is connected to a data wire, and the signal processing unit includes a signal amplifier and a signal processor. The current source receives a sorting signal, and provides a larger current draw to generate a larger disturbance signal according to the sorting signal.

In one embodiment, each LED apparatus further includes a sequence code register and a selector. The sequence code register is connected to the comparator. The selector is connected to the counter, the sequence code register, and the comparator. When a comparison result between the serial number and one of the sequence codes is the same, the comparator controls the sequence code register to receive a replacement signal having a new serial number with smaller number of bits than the sequence code, and store the new serial number.

In one embodiment, the control device sends a plurality of replacement signals to each of the LED lamps, and each LED lamp has the sequence code and the new serial number. When the comparator of the LED lamp and the sequence code register receive the replacement signals, after the comparator compares the sequence code and the serial number and confirms that the sequence code and the serial number are the same, the comparator controls the sequence code register to store the new serial number to replace the sequence code.

In one embodiment, when a comparison result between the serial number and one of the sequence codes is the same, after the control device detects the disturbance signal, the control device immediately sends the replacement signal and then sends the next sequence codes.

In one embodiment, a comparison result between the serial number and one of the sequence codes is the same, the comparator controls the sequence code register to detect the number of times the disturbance signal and records the replacement signal, and then controls the sequence code register to store the new serial number.

In one embodiment, the control device is configured to provide sequence codes in an incremental manner until at least two instances of a disturbance signal are detected, wherein an increment value is determined based on a difference between the sequence codes respectively corresponding to the first two detected disturbance signals, a new initial value of the sequence codes is generated based on the increment value, and the control device continues to provide the sequence codes based on the new initial value.

In one embodiment, the control device is configured to provide sequence codes in a decremental manner until at least two instances of the disturbance signal are detected, wherein a decrement value is determined based on a difference between the sequence codes respectively corresponding to the first two detected disturbance signals, a new initial value of the sequence codes is generated based on the decrement value, and the control device continues to provide the sequence codes based on the new initial value.

A third objective of the present disclosure is to provide a LED apparatus. The LED apparatus includes a sequencing circuit and a sorting circuit. The sequencing circuit generates a serial number and store the serial number according to a voltage value generated after power is supplied. The sorting circuit receives a plurality of sequence codes to the LED apparatus, and compares its own serial number with the plurality of sequence codes. When a comparison result between the serial number and one of the sequence codes is the same, the LED apparatus generates a disturbance signal.

A fourth objective of the present disclosure is to provide a LED lamp. The LED lamp includes two power pins, at least one LED, a LED apparatus, and a package. The two power pins receive an external DC power source. The at least one LED is coupled to the two power pins. The LED apparatus is coupled to the two power pins and the at least one LED, and drives the LED. The LED apparatus includes a sequencing circuit and a sorting circuit. The sequencing circuit generates a serial number and store the serial number according to a voltage value generated after receiving the DC power source. The sorting circuit receives a plurality of sequence codes to the LED apparatus, and compares its own serial number with the sequence codes. When a comparison result of the serial number and one of the sequence codes is the same, the LED apparatus generates a disturbance signal. The package packages the LED apparatus, the at least one LED, and a part of the two power pins, and the other part of the two power pins is exposed outside the package.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a block circuit diagram of a light-emitting diode (LED) light string having a two-wire structure according to a first embodiment of the present disclosure.

FIG. 2 is a block circuit diagram of the LED light string having the two-wire structure according to a second embodiment of the present disclosure.

FIG. 3 is a block circuit diagram of the LED light string having the two-wire structure according to a third embodiment of the present disclosure.

FIG. 4 is a block circuit diagram of the LED light string having the two-wire structure according to a fourth embodiment of the present disclosure.

FIG. 5 is a block circuit diagram of the LED light string having the two-wire structure according to a fifth embodiment of the present disclosure.

FIG. 6 is a block circuit diagram of a sequencing circuit according to a first embodiment of the present disclosure.

FIG. 7 is a block circuit diagram of the sequencing circuit according to a second embodiment of the present disclosure.

FIG. 8 is a detailed block circuit diagram of the sequencing circuit in FIG. 6.

FIG. 9 is a block circuit diagram of an LED apparatus having a two-wire structure according to a first embodiment of the present disclosure.

FIG. 10 a schematic waveform diagram of voltage detection and time counting of the plurality of LED apparatuses according to the present disclosure.

FIG. 11 is a block circuit diagram of the LED light string having a three-wire structure according to a first embodiment of the present disclosure.

FIG. 12 is a block circuit diagram of the LED light string having the three-wire structure according to a second embodiment of the present disclosure.

FIG. 13 is a block circuit diagram of the LED apparatus having a three-wire structure according to a first embodiment of the present disclosure.

FIG. 14 is a block circuit diagram of the LED apparatus having the three-wire structure according to a second embodiment of the present disclosure.

FIG. 15 is a block circuit diagram of the LED apparatus having the three-wire structure according to a third embodiment of the present disclosure.

FIG. 16 is a block circuit diagram of the LED apparatus having the three-wire structure according to a fourth embodiment of the present disclosure.

FIG. 17 is a schematic diagram of operating the LED light string according to a first embodiment of the present disclosure.

FIG. 18 is a schematic diagram of operating the LED light string according to a second embodiment of the present disclosure.

FIG. 19 is a schematic diagram of operating the LED light string according to a third embodiment of the present disclosure.

FIG. 20 is a schematic waveform diagram of a data format of a lighting signal according to the present disclosure.

FIG. 21 is a flowchart of a method of operating the LED light string according to the present disclosure.

FIG. 22 is a schematic diagram of a packaging structure of a LED lamp according to a first embodiment of the present disclosure.

FIG. 23 is a schematic diagram of a packaging structure of the LED lamp according to a second embodiment of the present disclosure.

FIG. 24 is a block circuit diagram of the LED apparatus having the two-wire structure according to a second embodiment of the present disclosure.

FIG. 25 is a block circuit diagram of the LED apparatus having the third-wire structure according to a fifth embodiment of the present disclosure.

### DETAILED DESCRIPTION

Reference will now be made to the drawing figures to describe the present disclosure in detail. It will be understood that the drawing figures and exemplified embodiments of present disclosure are not limited to the details thereof.

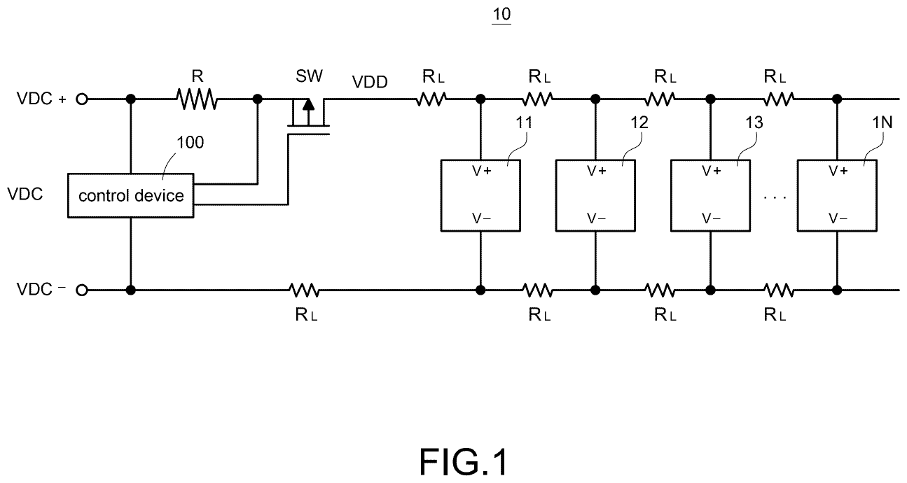

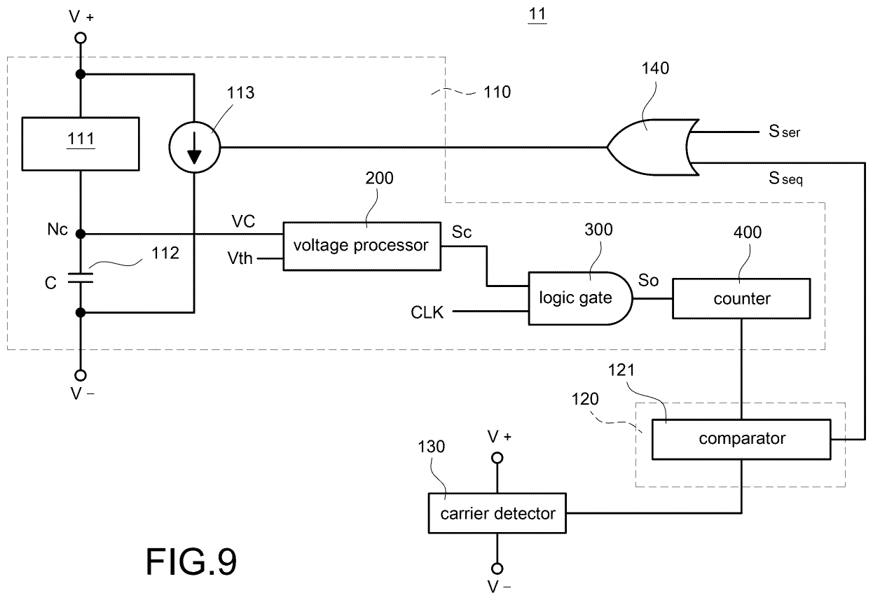

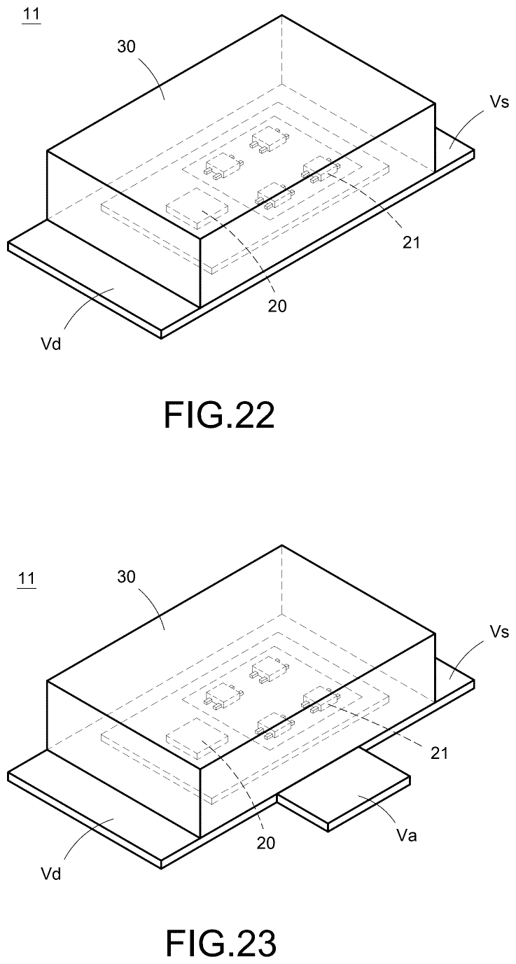

Please refer to FIG. 1 and FIG. 22, which show a block circuit diagram of a light-emitting diode (LED) light string having a two-wire structure according to a first embodiment of the present disclosure and a schematic diagram of a packaging structure of a LED lamp according to a first embodiment of the present disclosure. The so-called two-wire structure in the present disclosure means that the control and operation of the LED light string 10 are realized through two power wires. As shown in FIG. 1, the LED light string 10 receives a DC (direct-current) power source VDC, and the LED light string 10 includes a control device 100 and a plurality of LED lamps 11, 12, 13, . . . , 1N. As shown in FIG. 22, each LED lamp 11, 12, 13, . . . , 1N includes an LED apparatus 20, a plurality of LEDs 21, and a package 30. There is wire resistance R_{L} between two LED lamps 11, 12, 13, . . . , 1N. The control device 100 is connected between a positive voltage terminal VDC+ and a negative voltage terminal VDC− of the DC power source VDC. The LED apparatus 20 of each LED lamp 11, 12, 13, . . . , 1N includes a sequencing circuit 110 and a sorting circuit 120 (see FIG. 9 for details later).

Each sequencing circuit 110 performs sequencing according to the voltage values generated by the LED lamps 11, 12, 13, . . . , 1N at different sequence positions of the LED light string 10 upon receiving the DC power source VDC so as to generate and store serial numbers, in particular, the serial numbers are not necessarily a continuous series. For example, the serial numbers of the LED lamps 11, 12, 13, . . . , 1N are respectively #5, #9, . . . in a non-consecutive series, and the serial numbers in the non-consecutive series are gradually increasing values. The control device 100 provides a plurality of sequence codes to the LED apparatuses 20 of the LED lamps 11, 12, 13, . . . , 1N, and each sorting circuit 120 compares its own serial number with the sequence codes.

For the convenience of the explanation of the present disclosure, unless otherwise specified, the following embodiments will be described by taking the LED apparatus 20 of the first LED lamp 11 as an example.

When the comparison result between the serial number stored in the LED apparatus 20 of the first LED lamp 11 and one of the sequence codes is the same, the LED apparatus 20 generates a disturbance signal to the LED light string 10 to trigger the control device 100 to record the sequence code as the sequence position of the LED lamp 11 in the LED light string 10. In particular, the disturbance signal may be realized by a voltage disturbance signal or a current disturbance signal, and the following will take the current disturbance signal as an example. After the control device 100 completes the recording of the sequence codes corresponding to the respective serial numbers of each of the LED lamps 11, 12, 13, . . . , 1N to acquire the sequence positions of the LED lamps 11, 12, 13, . . . , 1N in the LED light string 10, a light working mode is performed.

The method by which the control device 100 provides multiple sequence codes could be implemented in various methods. For example, the control device 100 is configured to provide the sequence codes in a continuous (or discontinuous) incremental sequence (e.g., #1, #2, #3, . . . or #1, #3, #5, . . . ) or, upon detecting at least two disturbance signals, to further provide ascending sequence codes based on a difference between the sequence codes respectively corresponding to the first two LED lamps that have completed their sequencing modes.

The method provides the advantage of reducing the time required to determine the sequence code corresponding to the disturbance signal. For example, the control device 100 initially provide sequence codes in a continuous (or discontinuous) incremental sequence (e.g., #1, #2, #3, . . . or #1, #3, #5, . . . ). Upon providing sequence code #5, the LED apparatus 20 of LED lamp 11 generates a current disturbance signal. The control device 100 then continues to provide sequence codes #6 through #9 until a second current disturbance signal is generated from LED lamp 12. Upon detection of the second disturbance signal, the control device 100 calculates a first increment value based on a difference between the sequence codes of the first two responsive LED lamps (e.g., 4), and generates a new initial value of the sequence codes (e.g., #13) based on the increment value, and sequence codes are then continuously provided (e.g., #14, #15, #16).

If the third LED lamp responds to sequence code #16 and generates disturbance signal, the control device 100 determines a second increment value (e.g., 7), and uses it to generate the next sequence code starting value (e.g., #23). The sequencing modes then continues in the same manner until all LED lamps have been sequenced.

By means of the above approach, redundant transmissions of sequence codes can be effectively reduced, and the sequencing process can be accelerated. In particular, the increment value used by the control device 100 is dynamically generated based on the difference between the sequence codes of adjacent LED lamp that have completed sequencing mode, such that the sequence codes are provided according to a dynamically adjusted increment scheme. This not only prevents the generation of redundant sequence codes, but also significantly shortens the overall sequencing time.

In addition, the above-described method could also be implemented by having the control device 100 initiate sequencing from the last LED lamp and provide the sequence codes in a reverse continuous (or discontinuous) decremental sequence (e.g., #30, #29, #28, . . . or #30, #28, #26). The starting value of the sequence codes is similarly generated based on a decrement value calculated from the difference between the sequence codes of the first two LED lamps that h ave responded. The underlying technical principle is similar to that of the increment-based approach and will not be described in further detail herein.

The LED lamps 11, 12, 13, . . . , 1N of the LED light string 10 shown in FIG. 1 are connected in parallel. Moreover, the LED light string 10 further includes a switch unit SW and a resistor R, and the resistor R is connected to the switch unit SW. The switch unit SW is connected to a power supply path of the DC power source VDC, and is electrically connected to the control device 100 and the LED lamps 11, 12, 13, . . . , 1N respectively. When the LED apparatus 20 of the LED lamp 11 generates the current disturbance signal to the LED light string 10, the control device 100 is triggered to record the sequence code as the sequence position of the LED lamp 11 in the LED light string 10 according to a voltage difference of the current disturbance signal acquired by detecting a voltage across two terminals of the resistor R. In other words, when the LED apparatus 20 determines that the comparison result between the serial number and one of the sequence codes is the same, the LED apparatus 20 starts (activates) a current for a period of time. Therefore, the control device 100 can detect the change in the current through the voltage across the resistor R. The starting/activating current mentioned in the present disclosure refers to the disturbance signal that forms a voltage drop across the resistor R after the LED apparatus 20 activates the load circuit or drives the LED 21 to emit light, resulting in a large current draw. After repeated several times, the control device 100 is able to acquire the sequence positions of all the LED lamps 11, 12, 13, . . . , 1N, and then the sorting operation ends.

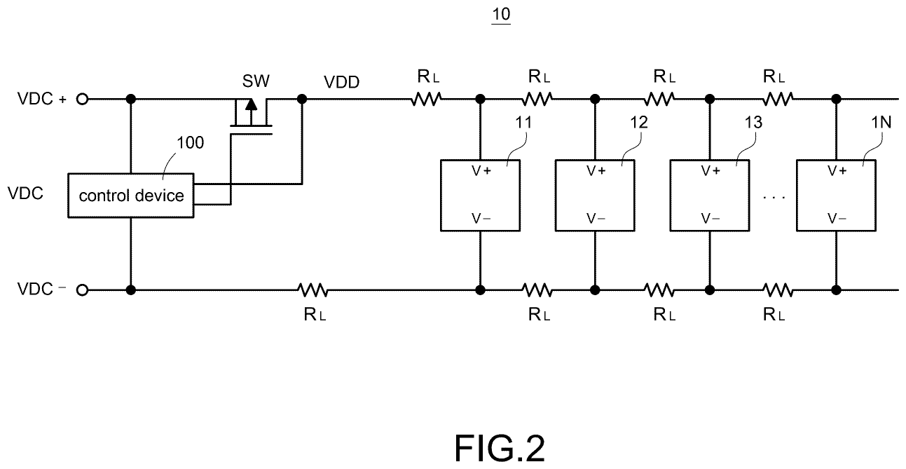

Please refer to FIG. 2, which shows a block circuit diagram of the LED light string having the two-wire structure according to a second embodiment of the present disclosure. Compared with FIG. 1, the embodiment shown in FIG. 2 does not have the resistor R. Since there is no resistor R, the control device 100 instead detects a voltage across the internal resistance of the switch unit SW, such as the resistance between the drain and the source of the switch unit SW so that the current disturbance signal may also be acquired accordingly.

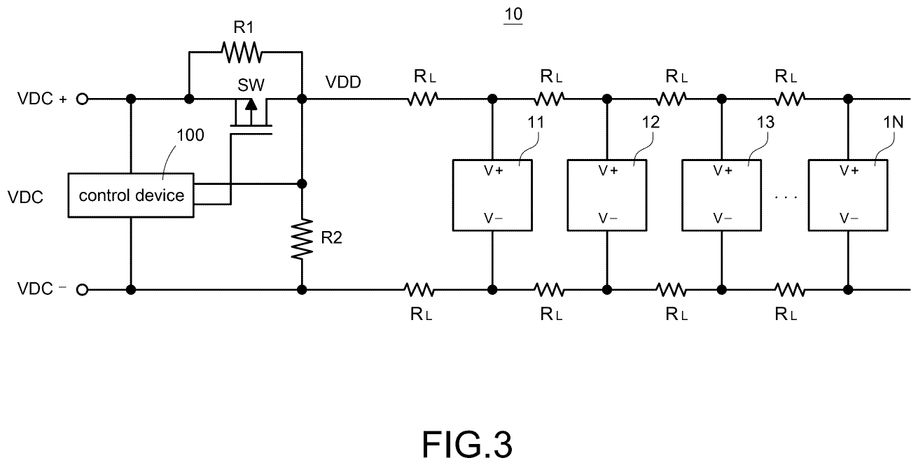

Please refer to FIG. 3, which shows a block circuit diagram of the LED light string having the two-wire structure according to a third embodiment of the present disclosure. Compared with FIG. 1, the embodiment shown in FIG. 3 has two resistors R1, R2, and the current disturbance signal may also be acquired by detecting both terminals of the resistor R1. Incidentally, the resistor R2 may also be omitted in the embodiment shown in FIG. 3.

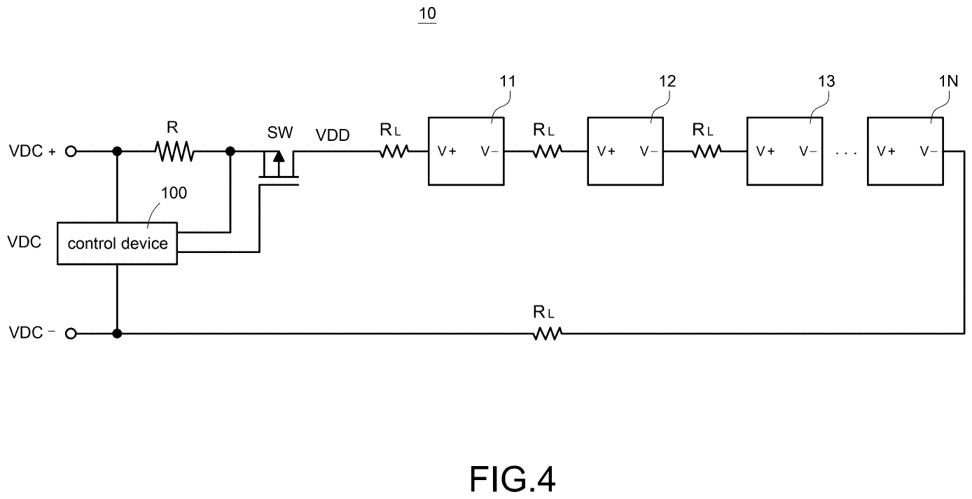

Please refer to FIG. 4, which shows a block circuit diagram of the LED light string having the two-wire structure according to a fourth embodiment of the present disclosure. Compared with FIG. 1, the LED lamps 11, 12, 13, . . . , 1N of the LED light string 10 shown in FIG. 3 are connected in series. Similarly, the control device 100 is triggered to record the sequence code as the sequence position of the LED lamp 11 in the LED light string 10 according to the current disturbance signal generated at two terminals of the resistor R.

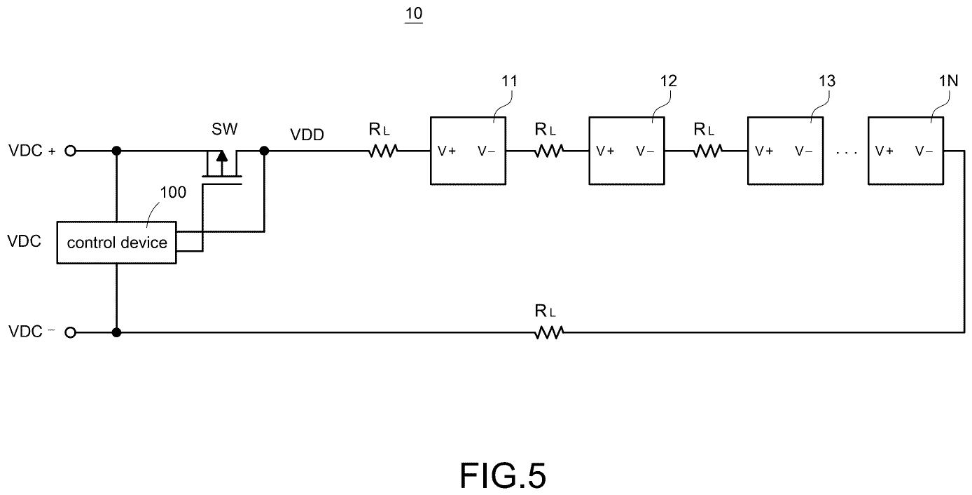

Please refer to FIG. 5, which shows a block circuit diagram of the LED light string having the two-wire structure according to a fifth embodiment of the present disclosure. Compared with FIG. 4, the embodiment shown in FIG. 5 does not have the resistor R. Since there is no resistor R, the control device 100 instead detects a voltage across the internal resistance of the switch unit SW, such as the resistance between the drain and the source of the switch unit SW so that the current disturbance signal may also be acquired accordingly.

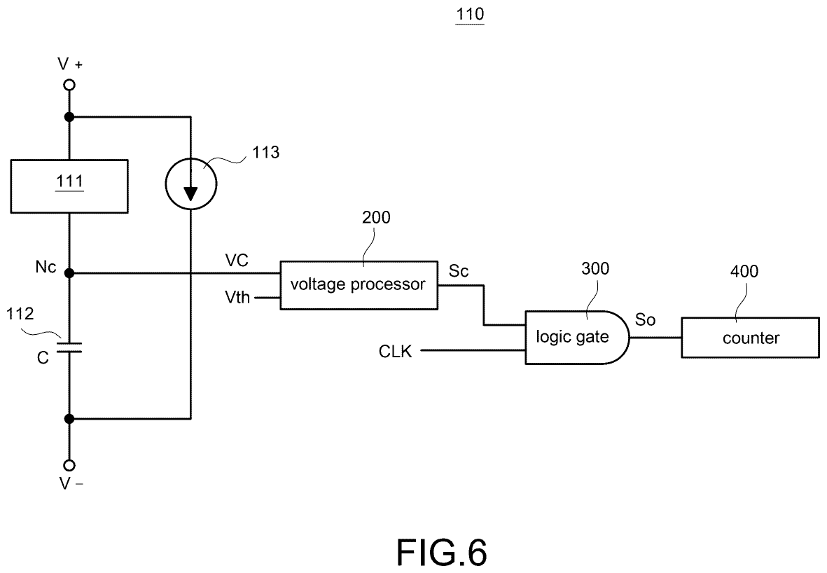

Please refer to FIG. 6, which shows a block circuit diagram of a sequencing circuit according to a first embodiment of the present disclosure. The sequencing circuit 110 shown in FIG. 6 includes a load component 111, a capacitive component 112, a current load 113, and a voltage processor 200. The load component 111 provides a resistance value. The capacitive component 112 is connected in series to the load component 111 at a node Nc, and the capacitive component 112 provides a capacitance value and generates an inner voltage VC at the node Nc. The current load 113 is connected in parallel to the load component 111 and the capacitive component 112 connected in series to provide a current path.

The voltage processor 200 receives the inner voltage VC and a threshold voltage Vth, and compares the inner voltage VC with the threshold voltage Vth to generate a comparison signal Sc. In particular, the sequencing circuit 110 counts time to acquire a time value from a starting time when the voltage processor 200 starts to generate the comparison signal Sc to a time when a level of the comparison signal Sc changes, and uses the time value for sequencing, and more details later.

As shown in FIG. 6, the sequencing circuit 110 further includes a logic gate 300 and a counter 400. The logic gate 300 receive the comparison signal Sc and a clock signal CLK, and performs the logic union operation on the comparison signal Sc and the clock signal CLK to generate an output signal So. The counter 400 receives the output signal So. In one embodiment, the logic gate 300 is an AND gate. The LED lamps 11, 12, 13, . . . , 1N receive the DC power source VDC and are supplied power by the DC power source VDC. When the inner voltage VC has not reached the threshold voltage Vth, the comparison signal Sc causes the output signal So to be the clock signal CLK and the counter 400 counts time. Until the inner voltage VC reaches the threshold voltage Vth, the comparison signal Sc causes the output signal So to stop the counter 400 from counting the clock signal CLK so as to acquire the time value during the counter counting time.

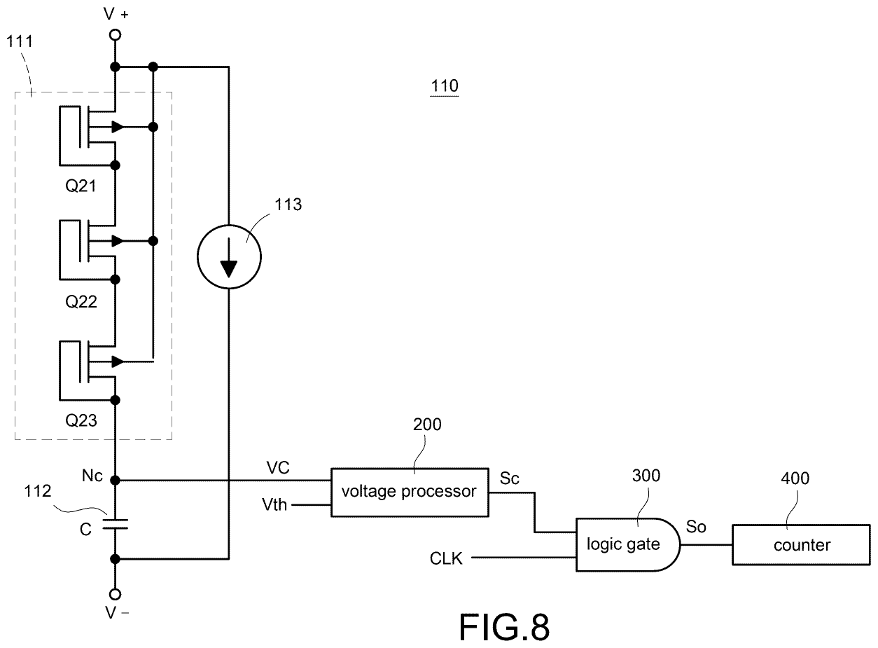

Please refer to FIG. 8, which shows a detailed block circuit diagram of the sequencing circuit in FIG. 6. In this embodiment, the load component 111 includes a plurality of transistor switches Q21, Q22, Q23 (for example, but not limited to P-type MOSFET switches) connected in series, and the capacitive component 112 is a capacitor C. The self-impedance values of the series-connected transistor switches Q21, Q22, Q23 form an equivalent impedance value. In particular, the equivalent impedance value and a capacitance value of the capacitor C are used to determine the time for charging the capacitive component 112 to the inner voltage VC. The smaller a time constant (the product of the impedance value and the capacitance value), the faster the capacitive component 112 is charged; on the contrary, the larger the time constant, the slower the capacitive component 112 is charged. However, the load component 111 of the present disclosure is not limited to the plurality of transistor switches Q21, Q22, Q23 connected in series, that is, it may also be composed of a single resistor, or a plurality of diodes and a transistor switch connected in series.

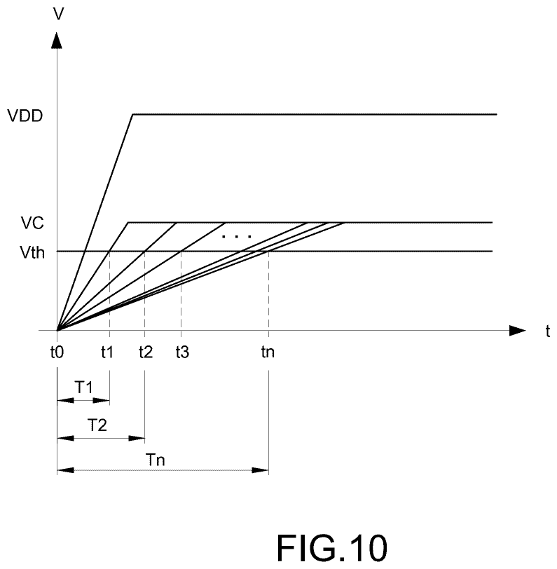

Please refer to FIG. 10, which shows a schematic waveform diagram of voltage detection and time counting of the plurality of LED apparatuses according to the present disclosure. The plurality of transition times t1, t2, . . . , tn when the inner voltages VC of the plurality of LED apparatuses 20 of the LED lamps 11, 12, 13, . . . , 1N respectively reach the threshold voltage Vth, i.e., the transition from the high level to the low level at the transition times respectively are produced. Therefore, the serial numbers of the corresponding LED lamps 11, 12, 13, . . . , 1N are determined according to a plurality of time differences T1, T2, . . . , Tn from the starting time t0 to the plurality of transition times t1, t2, . . . , tn respectively.

Specifically, taking the LED lamp 11 as an example, when the inner voltage VC has not reached the threshold voltage Vth, the comparison signal Sc is high level, and therefore the comparison signal Sc causes the output signal So to be the clock signal CLK and the counter 400 counts time. In one embodiment, the counter 400 counts time once in each clock cycle, and therefore the number of times of the clock signal CLK is accumulated during the counter 400 counting time when the inner voltage VC has not reached the threshold voltage Vth. Until the inner voltage VC reaches the threshold voltage Vth, the comparison signal Sc is changed to low level to cause the output signal So to stop the counter 400 from counting the clock signal CLK so as acquire an accumulated number, and the accumulated number can be correspondingly converted into a time value. As shown in FIG. 10, the plurality of accumulated times acquired by the LED lamps 11, 12, 13, . . . , 1N of the LED apparatus 20 are the corresponding plurality of transition times transition times t1, t2, . . . , tn. In other words, the first transition time t1 is corresponding to the accumulated number acquired by the first LED lamp 11 or the time value from the starting time to the time of transition related to the first lamp 11. Similarly, the second transition time t2 is corresponding to the accumulated number acquired by the second LED lamp 12 or the time value from the starting time to the time of transition related to the second LED lamp 12. So on and so forth, the Nth transition time tn is corresponding to the accumulated number acquired by the Nth LED lamp 1N or the time value from the starting time to the time of transition related to the Nth LED lamp 1N.

For example, the LED apparatus 20 internally generates a clock frequency of a specific frequency as the clock signal CLK as an example for illustration. When the control device 100 turns on the switch unit SW and the LED lamps 11, 12, 13, . . . , 1N are powered on at the staring time, i.e., the time t0 shown in FIG. 10, the LED apparatus 20 internally generates the clock frequency of the specific frequency as the clock signal CLK. For the first LED lamp 11, the voltage VDD charges the capacitive component 112 so that the inner voltage VC at the node Nc gradually changes. After the voltage processor 200 compares the inner voltage VC with the threshold voltage Vth, the comparison signal Sc outputted from the voltage processor 200 is in a high level if the inner voltage VC is less than the threshold voltage Vth. In this condition, the comparison signal Sc causes the output signal So outputted from the logic gate 300 to be the clock signal CLK, and therefore the counter 400 counts time once in each clock cycle to accumulate the number of times of the clock signal CLK. Until the time t1 (i.e., the first transition time), the inner voltage VC reaches the thresh voltage Vth, and the comparison signal Sc outputted from the voltage processor 200 is changed to low level. When the logic gate 300 receives the comparison signal Sc with the low level, the output signal So stops the counter 400 from counting the clock signal CLK so as acquire a first accumulated number, for example 100 times. In other words, the first accumulated number is corresponding to the first transition time. In particular, the time value from the starting time t0 to the first transition time t1 is the first time difference T1.

Similarly, for the second LED lamp 12, its operation is similar to the first LED lamp 11. The difference is that the time it takes for the inner voltage VC on the node Nc to gradually change to the threshold voltage Vth, that is, a second transition time t2 is longer than the first transition time t1, and correspondingly a second transition time t2 is acquired, and therefore a second accumulated number is greater than the first accumulated number, for example 150 times.

Therefore, so on and so forth, for the Nth LED lamp 1N, its operation is similar to the first LED lamp 11 and the second LED lamp 12. The difference is that the time it takes for the inner voltage VC on the node Nc to gradually change to the threshold voltage Vth, that is, a Nth transition time tn is longer than the second transition time t2, and correspondingly a Nth transition time tn is acquired, and therefore a Nth accumulated number is greater than the second accumulated number, for example 800 times. Therefore, the sequence of the plurality of LED circuits 10-1 to 10-N are determined based on the plurality of time differences T1, T2, . . . , Tn from the starting time t0 to the transition times t1, t2, . . . , tn. That is, the smaller the time difference T1, T2, . . . , Tn, the sequence (sequence number) of the LED lamps 11, 12, 13, . . . , 1N is earlier, and the larger the time difference T1, T2, . . . , Tn, the sequence (sequence number) of the LED light string is later.

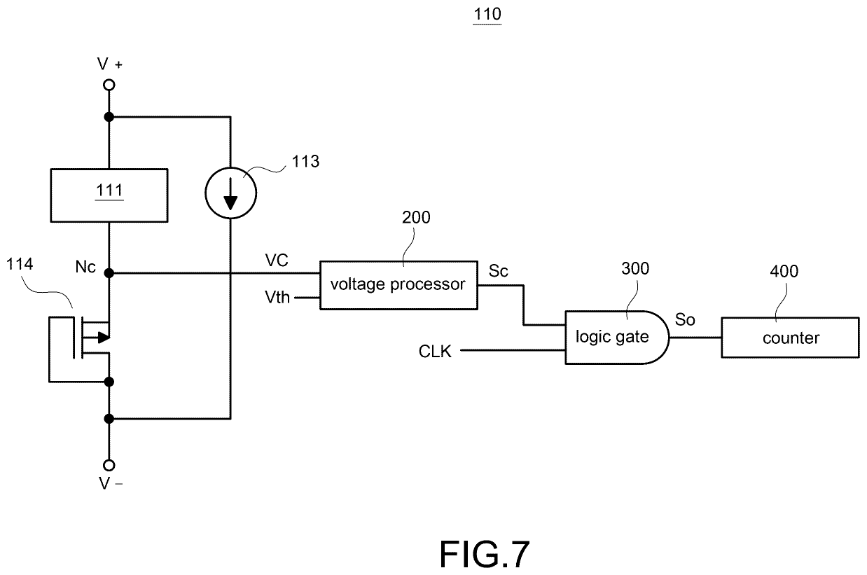

Please refer to FIG. 7, which shows a block circuit diagram of the sequencing circuit according to a second embodiment of the present disclosure. Compared with FIG. 6, in the embodiment shown in FIG. 7, a switch component 114 may be used to replace the capacitive component 112, and the sequencing operation can also be realized, so no further details are given here.

Please refer to FIG. 9, which shows a block circuit diagram of an LED apparatus having a two-wire structure according to a first embodiment of the present disclosure. As shown in FIG. 9, the LED apparatus 20 of the LED lamp 11 includes a sequencing circuit 110 and a sorting circuit 120. The operation of the sequencing circuit 110 is the same as that described in FIG. 6 to FIG. 8, and will not be described again, however, the difference is that the sorting circuit 120 includes a comparator 121. The comparator 121 is used to receive the sequence codes and the serial number provided by the sequencing circuit 110, and compare whether the serial number is the same one of the sequence codes. When the serial number is the same one of the sequence codes, the LED apparatus 20 generates a current disturbance signal to the LED light string 10 to trigger the control device 100 to record the sequence code as the sequence position of the LED lamp 11 in the LED light string 10 to perform the sorting operations.

Moreover, the LED apparatus 20 further includes a carrier detector 130. The carrier detector 130 receive a voltage VDD provided by the DC power source VDC, and when the voltage VDD is detected as a carrier signal voltage, the sorting circuit 120 is activated to operate.

Furthermore, the LED apparatus 20 further includes a current load controller 140. When entering sequencing, the control device 100 sends a sequencing signal Sser to the current load controller 140, and then the current load controller 140 activates the current load 113 to provide a current to charge the capacitive component 112 for sequencing. After the sequencing is completed within a predetermined time, the control device 100 stops sending the sequencing signal Sser so that the current load controller 140 disables the current load 113 to avoid wasting power. When entering sorting, the comparator 121 is electrically connected to the carrier detector 130, and the comparator 121 receives the sequence codes and the serial number provided by the sequencing circuit 110, and compare whether the serial number is the same one of the sequence codes. When the serial number is the same one of the sequence codes, the comparator 121 sends a sorting signal Sseq to the current load controller 140. When receiving the sorting signal Sseq, the current load controller 140 activates the current load 113 to perform current drawn so as to generate the current disturbance signal to the LED light string 10 for a period of time.

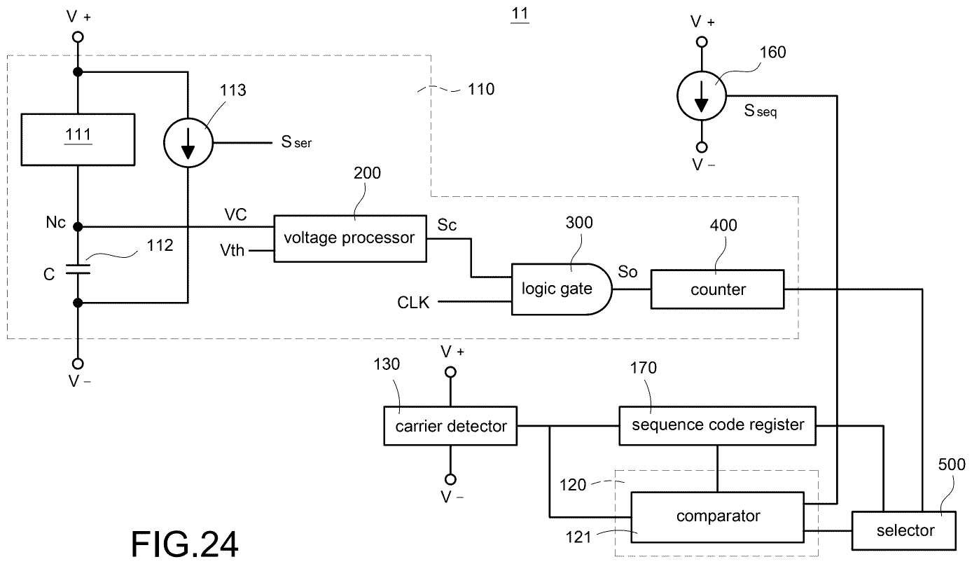

In order to enhance the effect of the current disturbance signal, the LED apparatus 20 further includes a current source 160 (see FIG. 24). When comparing that the serial number is the same one of the sequence codes, the comparator 121 simultaneously sends a sorting signal Sseq to activate the current source 160 so as to provide a larger current drawn to generate a larger current disturbance signal. Specifically, the current load 113 and the current source 160 are a load circuit with switch control. When the sorting signal Sseq is received and turned on, the LED apparatus 20 may be made to draw current. Depending on different implementations, only a single current load 113 with a current draw of about 80 mA to 100 mA is used. If it is necessary to further match with the current source 160, the current draw of the current load 113 is about 10 mA, and the current draw of the current source 160 is about 80 mA to 100 mA.

Furthermore, since the counter 400 of each LED lamp is affected by the line impedance and charging time when counting the initial serial number, the initial serial number may be different. In order to ensure that each counter 400 can successfully complete the sequencing operation, the data size of the initial sequence number will be designed to be a larger bit number, such as 20 bits. However, if the 20-bit initial serial number is directly used as the serial number of the light-emitting operation, not only the response speed of the entire LED light string 10 will be slowed, but it may also cause the design size of the LED apparatus 20 to increase, thereby increasing the costs. In order to overcome the above disadvantages, the original 20-bit serial number data may be replaced by a new set of smaller bytes, such as 8-bit serial number data. This approach can effectively improve system performance and reduce design and manufacturing costs, and the detailed technical content will be further explained later.

Please refer to FIG. 24, which shows a block circuit diagram of the LED apparatus having the two-wire structure according to a second embodiment of the present disclosure. The LED apparatus 20 of each LED lamp 11, 12, 13, . . . , 1N further includes a selector 500 and a sequence code register 170. The selector 500 is electrically connected to the comparator 121, the sequence code register 170, and the counter 400. The sequence code register 170 is electrically connected to the carrier detector 130. The selector 500 receives the serial number counted by the counter 400 and provides it to the comparator 121 for comparison with external data to complete the sorting mode. The following will describe in detail different methods of replacing the serial number data with a smaller bit size.

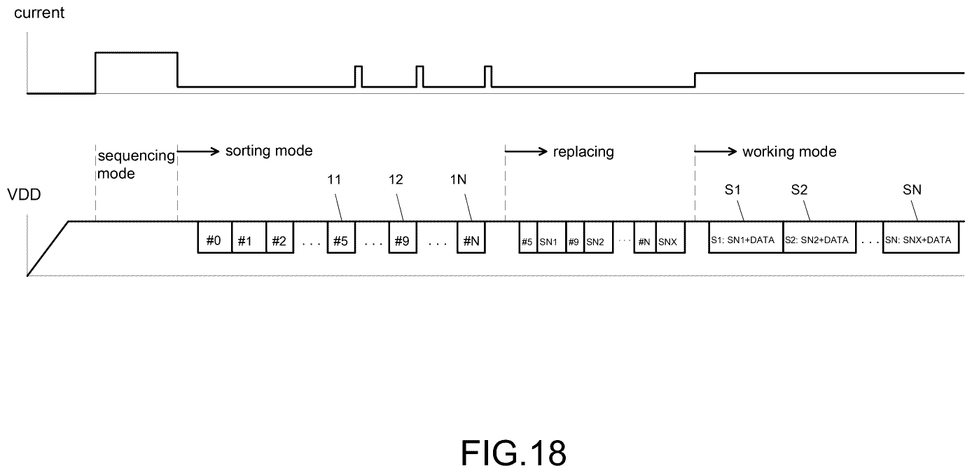

The first method, and refer to FIG. 18. After the control device 100 completes recording the sequence position of each LED lamp 11, 12, 13, . . . , 1N, it will sequentially and incrementally send a plurality of replacement signals having the original sequence codes and the new serial numbers (SN) of 8-bit data size to each LED lamp 11, 12, 13, . . . , 1N. At the same time, the original sequence codes are replaced by a new serial numbers as the sequence positions of the LED lamp 11, 12, 13, . . . , 1N in the LED light string 10. Specifically, taking the first LED lamp 11 as an example, the LED apparatus 20 of the LED lamp 11 and the sequence code register 170 receive the original sequence serial number of #5 and the replacement signal of 1. Afterward, the comparator 121 compares the original serial number provided by the selector 500 and confirms that they are the same, the comparator 121 controls the sequence code register 170 to store an 8-bit new serial number such as serial number 1, thereby replacing the original sequence serial number of 20-bit data size.

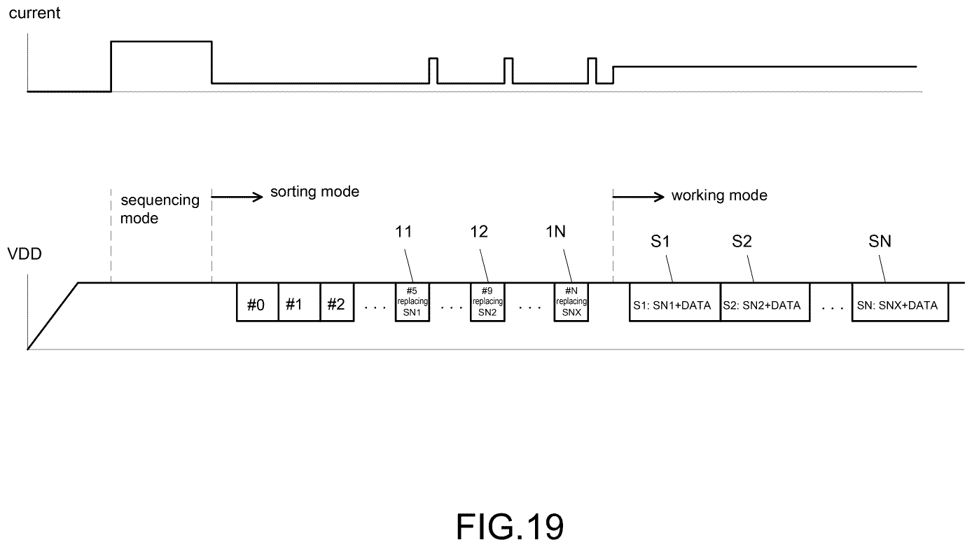

The second method, and refer to FIG. 19. The second method is similar to the first method, except that after a specific LED lamp is sequenced, the comparator 121 controls the sequence code register 170 to store the replacement signal received next. The control device 100 then sends a replacement signal, wherein the replacement signal only has a new serial number of 8-bit data size. Specifically, when the first LED lamp 11 is sequenced, the control device 100 will first send a replacement signal such as a serial number 1 of 8-bit data size. The comparator 121 of the LED lamp 11 controls the sequence code register 170 to store the serial number of 8-bit data size after receiving the replacement signal, thereby completing the replacement of the original sequence serial number of 20-bit data size. Afterward, the control device 100 continues to send the next original sequence codes as #6, #7, . . . , etc., so that the other LED lamps 12, 13, . . . , 1N can be sequenced. After the LED lamps are sequenced, the replacement method described above is performed.

The third method, and refer to FIG. 19. The third method is similar to the first method, except that when a specific LED lamp is sequenced, its comparator 121 controls the sequence code register 170 to generate and store a replacement signal. In particular, the replacement signal is a new serial number of 8-bit data size. Specifically, when the first LED lamp 11 completes the sequencing, a disturbance signal is generated. The comparator 121 sends a control command to control the sequence code register 170 to detect and record the number of disturbance signals on the LED light string, and the number of times this record is the replacement signal. Since the LED lamp 11 is the first one to generate the disturbance signal, the sequence code register 170 of the LED lamp 11 generates a replacement signal of a new serial number of 8-bit data size, such as serial number 1, according to the number of disturbance signals detected, such as 1, thereby replacing the original sequence serial number, such as #5. Similarly, after the second LED lamp 12 is sequenced, its sequence code register 170 generates a replacement signal of a new serial number of 8-bit data size, such as serial number 2, according to the number of disturbance signals detected, such as 2, and stores it to replace the original sequence serial number, such as #9.

Although the above three replacement methods are all based on the fifth embodiment of the two-wire structured LED apparatus as an example, they can also be applied to other two-wire structured LED apparatuses disclosed in the present disclosure and other three-wire structured LED apparatuses disclosed in the present disclosure.

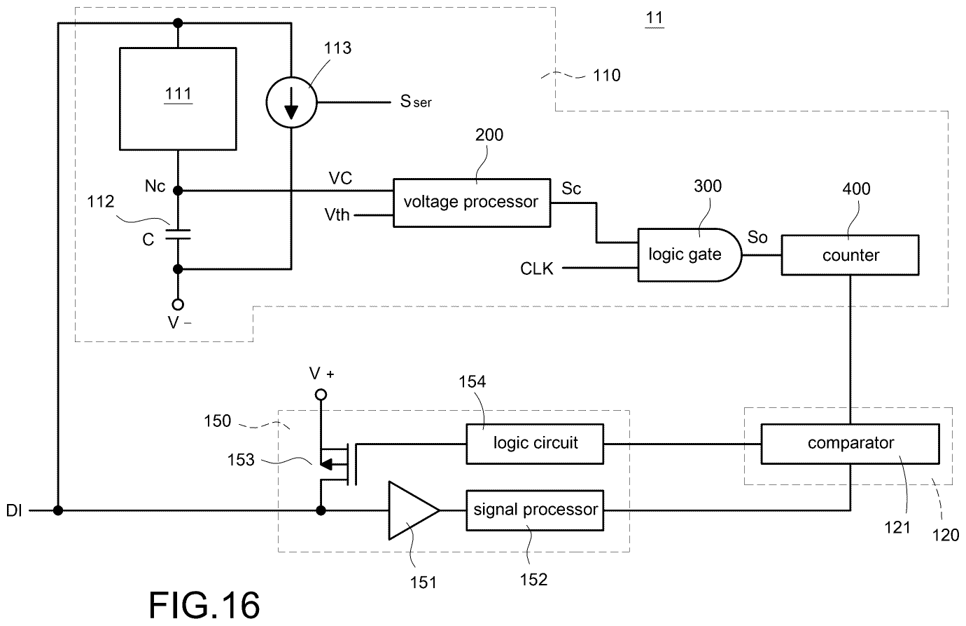

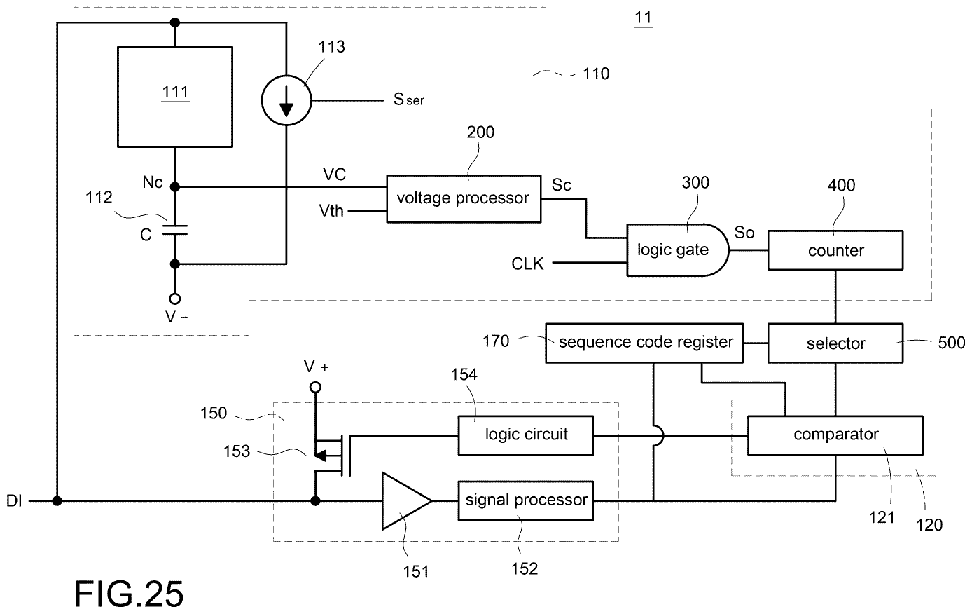

Please refer to FIG. 25, which shows a block circuit diagram of the LED apparatus having the third-wire structure according to a fifth embodiment of the present disclosure, and its structure is similar to that of FIG. 16. The difference is that the LED apparatus 20 is further provided with a selector 500 and a sequence code register 170 to perform the above-mentioned replacement methods. The selector 500 is electrically connected to the counter 400, the sequence code register 170, and the comparator 121. The sequence code register 170 is electrically connected to a signal processor 152. However, if the third method of the above-mentioned replacement methods is performed, the electrical connection relationship may also be omitted. When the first method of the above-mentioned replacement method is performed, taking the first LED lamp 11 as an example, the LED apparatus 20 of the LED lamp 11 and the sequence code register 170 receive the original sequence serial number of #5 and the replacement signal of 1 through the signal processor 152. Afterward, the comparator 121 compares the serial number of the counter 400 provided by the selector 500 and confirms that they are the same, the comparator 121 sends a control command to control the sequence code register 170to store a new serial number of 8-bit data size such as serial number 1, thereby replacing the original sequence serial number of 20-bit data size. The performances of the second method and the third method are the same as those of the above-mentioned two-wire structure, and thus will not be repeated.

Please refer to FIG. 22, which shows a schematic diagram of a packaging structure of a LED lamp according to a first embodiment of the present disclosure. The LED lamp includes two power pins Vd, Vs, at least one LED 21, one LED apparatus 20, and a package 30. The two power pins Vd, Vs receive a voltage. The at least one LED 21 is coupled to the two power pins Vd, Vs. The detailed description of the LED apparatus 20 may be found in the above contents, which will not be further described here. The package 30 is used to package the LED apparatus 20, the at least one LED 21, and a part of the two power pins Vd, Vs, and the other part of the two power pins Vd, Vs is exposed outside the package 30.

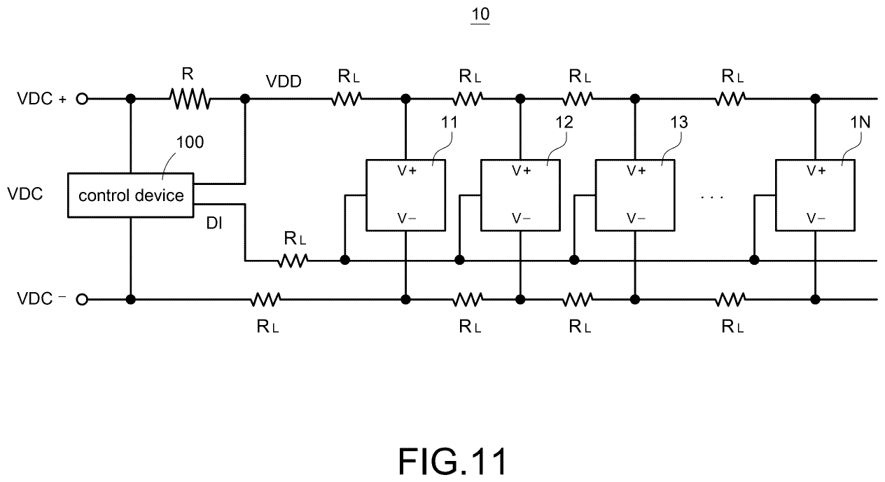

Please refer to FIG. 11, which shows a block circuit diagram of the LED light string having a three-wire structure according to a first embodiment of the present disclosure. Different from the above-mentioned two-wire structure, the so-called three-wire structure refers to the control and operation of the LED light string 10 being realized by two power wires and one data wire. Therefore, the control device 100 provides a data wire DI, and the data wire DI is connected to the LED apparatuses 20 of the LED lamp 11, 12, 13, . . . , 1N respectively. Furthermore, the embodiment shown in FIG. 11 has a resistor R, and therefore the control device 100 is triggered to record the sequence code as the sequence position of the LED lamp 11 in the LED light string 10 according to the current disturbance signal generated on the resistor R (which can be acquired by detecting a voltage across two terminals of the resistor R by the control device 100).

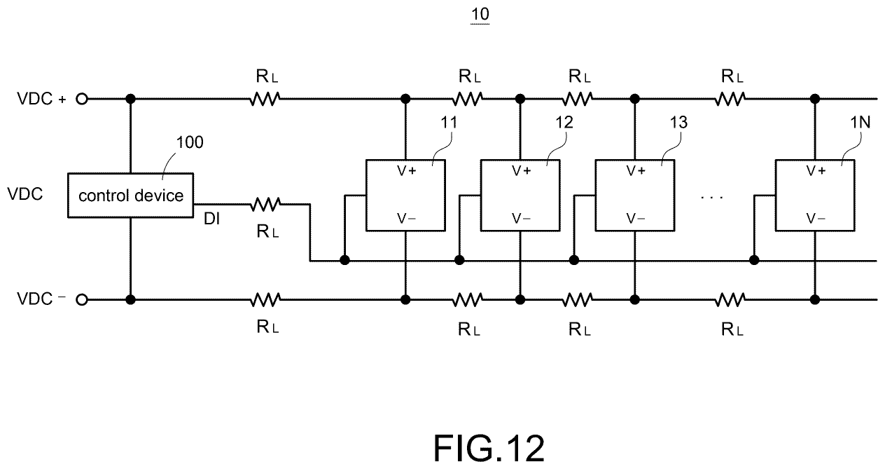

Please refer to FIG. 12, which shows a block circuit diagram of the LED light string having the three-wire structure according to a second embodiment of the present disclosure. Compared with FIG. 11, the embodiment shown in FIG. 12 does not have the resistor R. Since there is no resistor R, the control device 100 directly acquires the voltage disturbance signal through the wire resistance R_{L} of the data wire DI itself, and is triggered to record the sequence code as the sequence position of the LED lamp 11 in the LED light string 10.

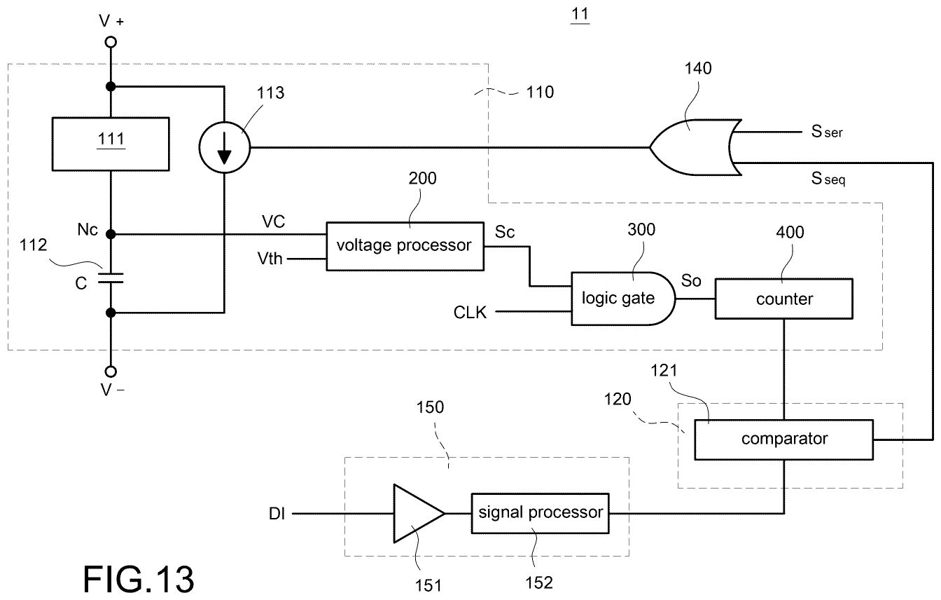

Please refer to FIG. 13, which shows a block circuit diagram of the LED apparatus having a three-wire structure according to a first embodiment of the present disclosure. The embodiment of FIG. 13, in conjunction with the three-wire structure of FIG. 11, can implement operations of sequencing through the power wires and sorting through the data wire DI. The operation mechanism of the sequencing and sorting is substantially the same as that of the implementation of FIG. 9, and will not be described in detail. The difference is that, since the data wire DI is used for sorting, the LED apparatus 20 further includes a signal processing unit 150. The signal processing unit 150 is connected to the data wire DI, and includes a signal amplifier 151 and a signal processor 152. In particular, the control device 100 sends the sequence codes to all the LED 11, 12, 13, . . . , 1N of the LED apparatus 20 through the data wire DI. Furthermore, in order to prevent the signal strength of the data wire DI from being too low, the signal amplifier 151 and the signal processor 152 are used for signal amplification and filtering so that signals of the sequence codes can be completely sent to the comparator 121.

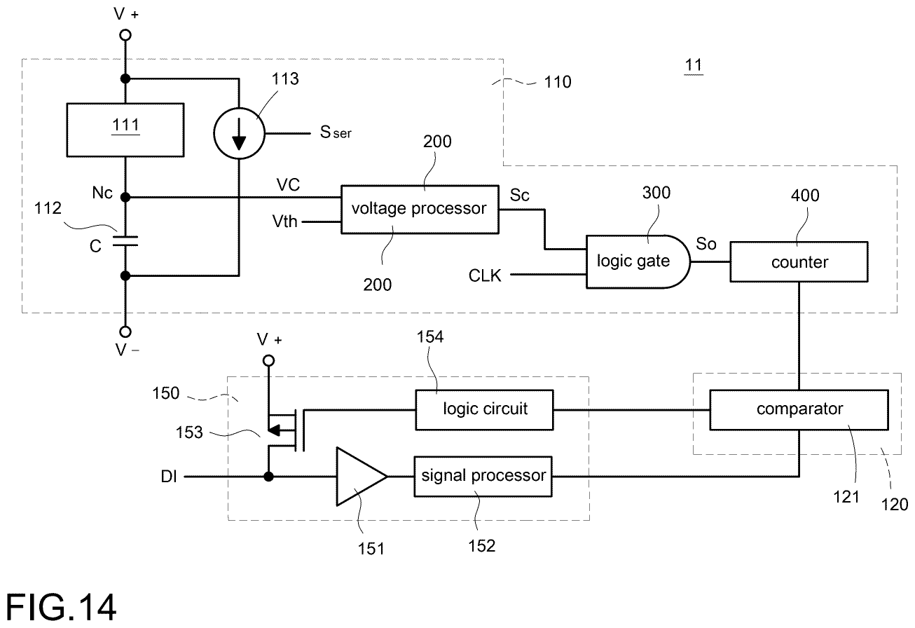

Please refer to FIG. 14, which shows a block circuit diagram of the LED apparatus having the three-wire structure according to a second embodiment of the present disclosure. The LED apparatus 20 further includes a signal processing unit 150 connected to the data wire DI, and the signal processing unit 150 includes a signal amplifier 151, a signal processor 152, a switch 153, and a logic circuit 154. The switch 153 is connected to a voltage source (not shown), and the current load 113 directly receives a sequencing signal Sser. The embodiment of FIG. 14, in conjunction with the three-wire structure of FIG. 12, can implement operations of sequencing through the power wires and sorting through the data wire DI. The implementation of the specific sequencing operation is roughly the same as above and will not be repeated here. The difference is that, during sequencing, the control device 100 sends a sequencing signal Sser to activate the current load 113 to provide current for sequencing. When the comparator 121 determines that the comparison result between the serial number and one of the sequence codes is the same, the comparator 121 sends a signal to control the logic circuit 154 to turn on the switch 153 for a period of time. During the conduction (turned-on) period, since the switch 153 is electrically connected to the voltage source, a voltage is applied to the data wire DI to generate a current disturbance signal to the LED light string 10, the control device 100 records the sequence code as the sequence position of the LED lamp 11 in the LED light string 10 according to the voltage change fed back on the data wire DI. After repeated several times, the control device 100 is able to acquire the sequence positions of all the LED lamps 11, 12, 13, . . . , 1N, and then the sorting operation ends.

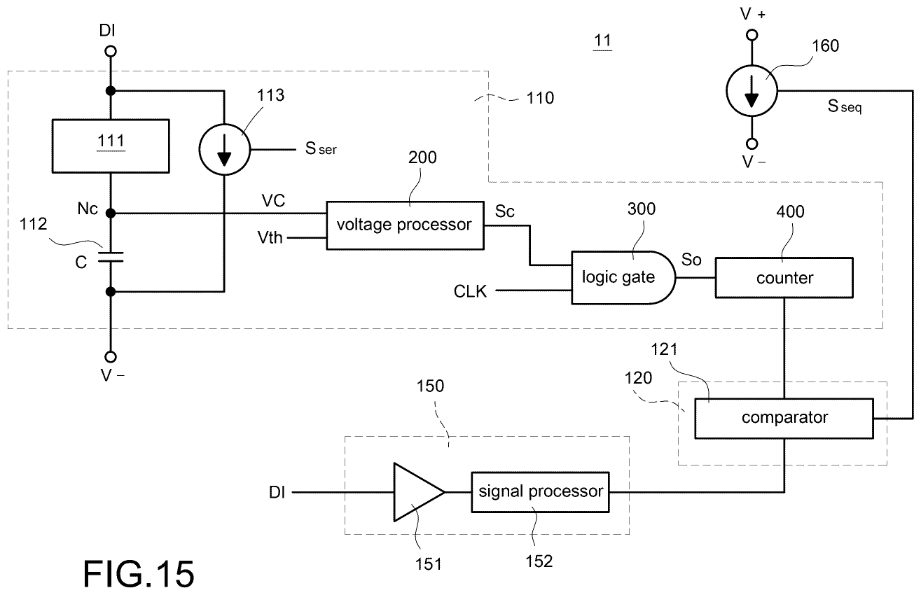

Please refer to FIG. 15, which shows a block circuit diagram of the LED apparatus having the three-wire structure according to a third embodiment of the present disclosure. The LED apparatus 20 further includes a signal processing unit 150 and a current source 160. The signal processing unit 150 is connected to the data wire DI, and includes a signal amplifier 151 and a signal processor 152, having the same functions as those in the embodiment of FIG. 13. The current source 160 receives the sorting signal Sseq and is controlled by the sorting signal Sseq. The embodiment of FIG. 15, in conjunction with the three-wire structure of FIG. 11, can implement operations of sequencing through the data wire DI and sorting through the power wires. The difference from the previous embodiments is that when the sequencing is completed, the counter 400 provides a sequencing signal Sser to the current load 113 to disable it. When the comparator 121 determines that the comparison result between the serial number and one of the sequence codes is the same, the comparator 121 sends a sorting signal Sseq to control the current source 160 to activate a current to the LED light string for a period of time. Therefore, the control device 100 can detect the change of the current through the voltage change fed back from the power wires and record the sequence code as the sequence position of the LED lamp 11 in the LED light string 10. After repeated several times, the control device 100 is able to acquire the sequence positions of all the LED lamps 11, 12, 13, . . . , 1N, and then the sorting operation ends.

Please refer to FIG. 16, which shows a block circuit diagram of the LED apparatus having the three-wire structure according to a fourth embodiment of the present disclosure. The LED apparatus 20 further includes a signal processing unit 150 connected to the data wire DI, and the signal processing unit 150 includes a signal amplifier 151, a signal processor 152, a switch 153, and a logic circuit 154. The embodiment of FIG. 16, in conjunction with the three-wire structure of FIG. 12, can implement operations of sequencing through the data wire DI and sorting through the data wire DI. The implementation is substantially the same as the previous implementation of FIG. 14, and the only difference is that the data wire DI is provided to control the operation of the sequencing circuit 110.

Please refer to FIG. 23, which shows a schematic diagram of a packaging structure of the LED lamp according to a second embodiment of the present disclosure. The specific structure of the LED lamp 11 is roughly the same as that of the above-mentioned FIG. 22, which will not be further described here. The difference is that the LED lamp 11 further includes a data pin Va. By connecting the data pin Va to the data wire DI, the three-wire LED light string 10 shown in FIG. 11 to FIG. 16 can be applied, and the package 30 is used to package the LED apparatus 20, the at least one LED 21, a part of the two power pins Vd, Vs, and a part of the data pin Va, and the other part of the two power pins Vd, Vs and the other part of the data pin Va are exposed outside the package 30.

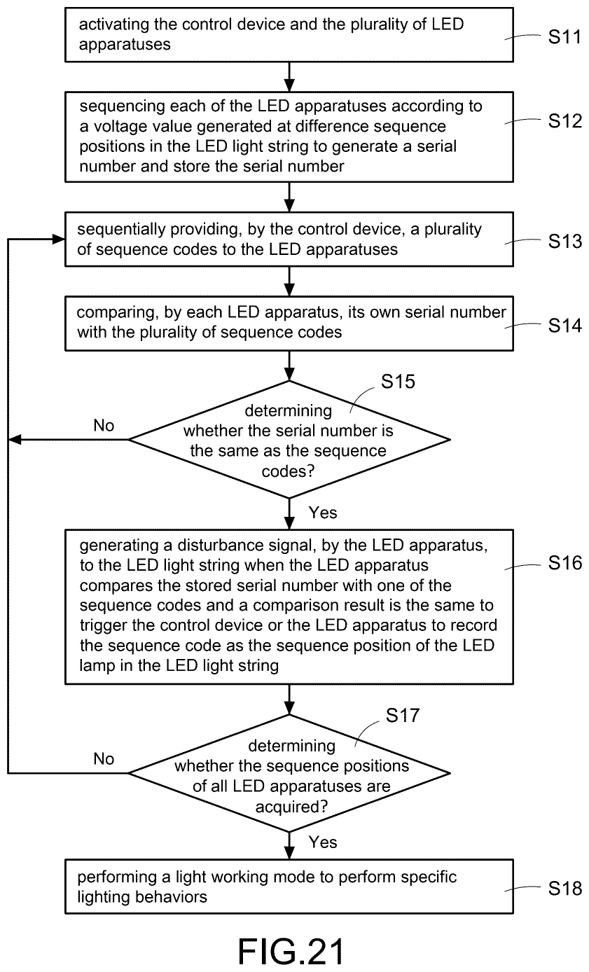

Please refer to FIG. 21, which shows a flowchart of a method of operating the LED light string according to the present disclosure. The LED light string 10 includes a control device 100 and a plurality of LED lamps 11, 12, 13, . . . , 1N connected with the control device 100. Each LED lamp 11, 12, 13, . . . , 1N includes a LED apparatus 20. For other circuits and devices included in the LED light string 10 and the LED apparatus, please refer to the above-mentioned contents and will not be described in detail here.

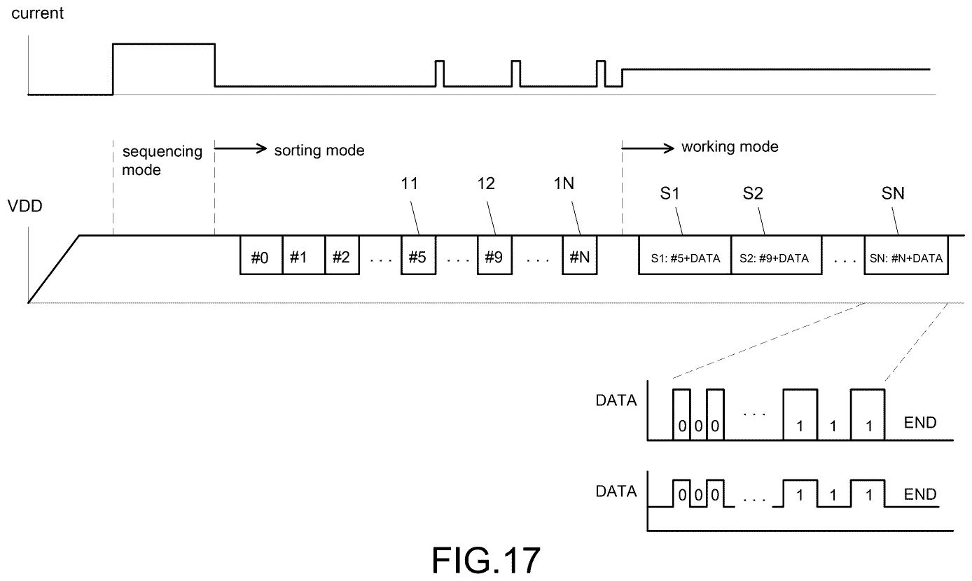

The method includes the following steps of: first, receiving a DC power source VDC by the LED light string to activate the control device 100 and the plurality of LED lamps 11, 12, 13, . . . , 1N, where each LED lamp 11, 12, 13, . . . , 1N includes a LED apparatus 20 (step S11). Afterward, sequencing each of the LED apparatuses 20 according to a voltage value generated at difference sequence positions in the LED light string 10 to generate a serial number and store the serial number (step S12), in particular, the serial numbers are not necessarily a continuous series. Please refer to FIG. 17, which shows a schematic diagram of operating the LED light string according to a first embodiment of the present disclosure, and where the first LED lamp 11 has a serial number #5, the second LED lamp 12 has a serial number #9, and the serial numbers of the other LED lamps will be gradually larger values.

Afterward, providing, by the control device 100, a plurality of sequence codes to the LED apparatuses 20 of the plurality of LED lamps 11, 12, 13, . . . , 1N (step S13), and comparing, by each LED apparatus 20, its own serial number with the plurality of sequence codes (step S14), that is, determining whether the serial number is the same as the sequence codes (step S15). If the determination result of step S15 is “No”, step S14 is performed to compare the own serial number with the sequence codes again. On the contrary, if the determination result of step S15 is “Yes”, the LED apparatus 20 generates a disturbance signal to the LED light string 10 (see FIG. 17). For example, when the first LED lamp 11 having the serial number #5 and its serial number is the same as the sequence code #5, or when the second LED lamp 12 having the serial number #9 and its serial number is the same as the sequence code #9, and therefore triggering the control device 100 or the LED apparatus 20 to record the sequence code as the sequence position of the LED lamp 11 in the LED light string 10 (step S16). In particular, the disturbance signal may be implemented by a voltage disturbance signal or a current disturbance signal, and the specific implementation has been described above and will not be repeated here. In addition, please refer to FIG. 18 and FIG. 19 simultaneously. In another embodiment, in step S13, the control device 100 further counts the number of times the voltage value changes due to the disturbance signal. Correspondingly, in step S16, the control device 100 and each LED apparatus 20 record and replace (overwrite) the number of voltage value changes into a new sequence code and a new serial number. As shown in FIG. 18, after all the sequencing modes are completed, the replacement (overwriting) is performed uniformly, or as shown in FIG. 19, the replacement (overwriting) may be performed one by one while each LED apparatus 20 sends a disturbance signal. The specific replacement (overwriting) implementation has been described above and will not be repeated here.

In another embodiment, in step S13 further including: the control device 100 is configured to provide sequence codes in a continuous (or discontinuous) incrementing sequence until at least two disturbance signals are detected. Based on a difference between the sequence codes respectively corresponding to the LED lamp 11 and 12 that generated the first two disturbance signals, an increment value (e.g., 4) is calculated. A new initial value of the sequence codes (e.g., #13) is then generated based on the increment value, and ascending sequence codes are continuously provided thereafter. The specific implementation of this method has been previously described and will not be repeated here.

Afterward, determining whether the sequence positions of all LED apparatuses are acquired (step S17). If the determination result of step S17 is “No”, step S13 is performed to provide the plurality of sequence codes to each of the LED lamps 11, 12, 13, . . . , 1N of the LED apparatuses 20. Until the recording of the sequence codes corresponding to the serial numbers of all the LED apparatuses 20 is completed, the sequence positions of the LED lamps 11, 12, 13, . . . , 1N in the LED light string 10 are acquired.

On the contrary, If the determination result of step S17 is “Yes”, performing a light working mode (step S18). In the working mode, the control device 100 sends a lighting signal to each LED apparatus 20 of the LED lamps 11, 12, 13, . . . , 1N according to the recorded sequence codes and light working mode so as to control the LED lamps 11, 12, 13, . . . , 1N to perform specific lighting behaviors.

In particular, in step S18, each LED apparatus 20 receives a lighting signal having a sequence code and a lighting information or a lighting signal having a lighting information involving the sequence of the sequence code. When the sequence code matches the serial number stored in the counter 400, the LED lamps 11, 12, 13, . . . , 1N perform specific lighting behaviors of the lighting information. Specifically, the specific lighting behaviors refer to the lighting effect, such as continuous lighting, color change, fast flashing, slow flashing, marquee, etc., produced by controlling the LEDs 21 by the LED apparatus 20 according to the lighting signal.

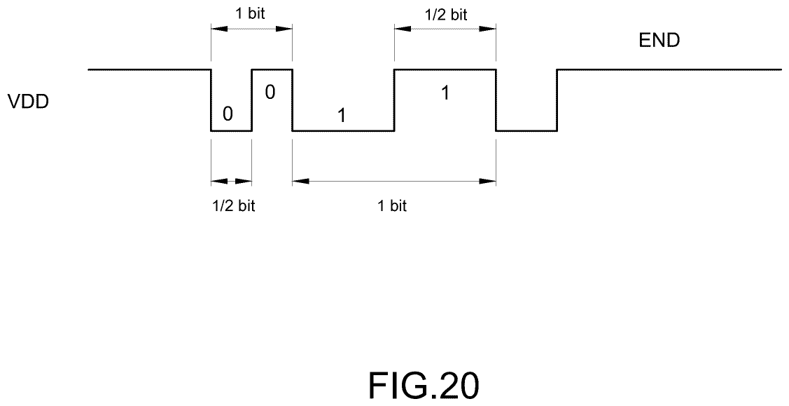

Please refer to FIG. 20, which shows a schematic waveform diagram of a digital data format of a lighting signal, replacement signal or sequence code according to the present disclosure. These signals or codes provided by the control device 100 have a plurality of pulses having a plurality of pulse widths, the replacement signal and the sequence code can be implemented as a single pulse with a fixed or variable pulse width, and the sequencing modes as referred to in the present invention may be carried out by the LED device 20 through a pulse-counting reception method.

The control device 100 and the LED apparatus 20 respectively use the pulse width of each pulse with single high level or single low level as a judgment reference of a digital signal. For example, as shown in FIG. 20, the original 1-bit (i.e., the pulse width with a high level plus a low level) is used as the judgment reference of the digital signal. In the present disclosure, only needs to use ½ bit, that is, the pulse width with a single high level or a single low level as the judgment reference of the digital signal (i.e., 0 or 1) so that more LED apparatuses can be transmitted, or with the same number of lights, the amount of data can be greatly reduced.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A method of operating a LED light string, the LED light string comprising a control device and a plurality of LED lamps connected with the control device, and each LED lamp comprising a LED apparatus, the method comprising steps of:
(a) receiving a DC power source, by the LED light string, to activate the control device and each LED apparatus,
(b) sequencing each of the LED apparatuses upon receiving the DC power source at difference sequence positions in the LED light string to generate a serial number and store the serial number, wherein the serial numbers are different from each other,
(c) providing, by the control device, a plurality of sequence codes to the LED apparatuses, and comparing, by each of the LED apparatus, its own serial number with the plurality of sequence codes,
(d) generating a disturbance signal, by the LED apparatus, to the LED light string when the LED apparatus compares the stored serial number with one of the sequence codes and a comparison result is the same to trigger the control device or the LED apparatus to record the sequence code as the sequence position of the LED lamp in the LED light string, and
(e) repeatedly performing, by the control device, step (c) and step (d), to acquire the sequence positions of LED apparatuses in the LED light string until the recording of the sequence codes corresponding to the respective serial numbers of each of the LED lamps is completed.

2. The method of operating a LED light string as claimed in claim 1, wherein in step (c) further comprising a step of: counting the number of times the voltage value changes, and in step (d), the control device or the LED apparatus records the number of times the voltage value changes as the sequence code.

3. The method of operating a LED light string as claimed in claim 1, wherein after step (e), the LED apparatus receives a lighting signal having a sequence code and a lighting information or a lighting signal having a lighting information involving a sequence of the sequence code; when the sequence code or the sequence of the sequence code matches the serial number, the LED apparatus performs specific lighting behaviors of the lighting information.

4. The method of operating a LED light string as claimed in claim 3, wherein sequence code, the lighting signal provided by the control device has a plurality of pulses having a plurality of pulse widths, wherein the control device and the LED apparatus respectively use a pulse width with a single high level or a single low level as a judgment reference of a digital signal.

5. The method of operating a LED light string as claimed in claim 1, wherein in step (c) further comprising the control device is configured to provide sequence codes in an incremental manner until at least two instances of a disturbance signal are detected, wherein an increment value is determined based on a difference between the sequence codes respectively corresponding to the first two detected disturbance signals, a new initial value of the sequence codes is generated based on the increment value, and the control device continues to provide the sequence codes based on the new initial value.

6. The method of operating a LED light string as claimed in claim 1, wherein in step (c) further comprising the control device is configured to provide sequence codes in a decremental manner until at least two instances of the disturbance signal are detected, wherein a decrement value is determined based on a difference between the sequence codes respectively corresponding to the first two detected disturbance signals, a new initial value of the sequence codes is generated based on the decrement value, and the control device continues to provide the sequence codes based on the new initial value.

7. A LED light string receiving a DC power source, the LED light string comprising:
a control device, and
a plurality of LED lamps, each LED lamp comprising a LED apparatus, and the LED apparatus comprising:
a sequencing circuit configured to sequence each LED apparatus upon receiving DC power source at difference sequence positions in the LED light string to generate a serial number and store the serial number, wherein the control device is configured to provide a plurality of sequence codes to the LED apparatuses, wherein the serial numbers are different from each other, and
a sorting circuit configured to compare its own serial number with the plurality of sequence codes,
wherein when the LED apparatus compares the stored serial number with one of the sequence codes and a comparison result is the same, the LED apparatus is configured to generate a disturbance signal to the LED light string to trigger the control device or the LED apparatus to record the sequence code as the sequence position of the LED lamp in the LED light string,
wherein until the recording of the sequence codes corresponding to the serial numbers of the LED lamp is completed, the sequence positions of LED apparatuses in the LED light string are acquired.

8. The LED light string as claimed in claim 7, wherein the LED light string further comprises:
a switch unit connected to the DC power source, and
at least one resistor connected to the switch unit,
wherein the disturbance signal generated on the resistor is configured to trigger the control device or the LED apparatus to record the sequence code as the sequence position of the LED lamp in the LED light string.

9. The LED light string as claimed in claim 7, wherein the LED light string further comprises:
a switch unit connected to the DC power source,
wherein the disturbance signal generated on an internal resistance of the switch unit is configured to trigger the control device or the LED apparatus to record the sequence code as the sequence position of the LED lamp in the LED light string.

10. The LED light string as claimed in claim 7, wherein the sequencing circuit comprises:
a load component configured to provide a resistance value,
a capacitive component or a switch component connected in series to the load component at a node, and the capacitive component or the switch component configured to generate an inner voltage at the node,
a current load connected in parallel to the load component and the capacitive component or the switch component connected in series, and the current load configured to provide a current path, and
a voltage processor configured to receive the inner voltage, and compare the inner voltage with a threshold voltage to generate a comparison signal,
wherein the sequencing circuit counts time to acquire a time value from a starting time when the voltage processor starts to generate the comparison signal to a time when a level of the comparison signal changes, and the serial number of the LED apparatus is generated according to the time value.

11. The LED light string as claimed in claim 10, wherein the sequencing circuit further comprises:
a logic gate configured to receive the comparison signal and a clock signal, and perform a logic operation on the comparison signal and the clock signal to generate an output signal, and
a counter configured to receive the output signal,
wherein the LED apparatus is supplied power by the DC power source and the inner voltage is gradually changed; when the inner voltage has not reached the threshold voltage, the comparison signal causes the output signal to be the clock signal and the counter counts time;
until the inner voltage reaches the threshold voltage, the comparison signal causes the output signal to stop the counter from counting so as to acquire the time value during the counter counting time.

12. The LED light string as claimed in claim 11, wherein the sorting circuit comprises:
a comparator configured to receive the sequence codes and the serial number provided by the sequencing circuit, and compare the serial number with the sequence codes.

13. The LED light string as claimed in claim 11, wherein each LED apparatus further comprises:
a carrier detector configured to receive a voltage provided by the DC power source, and when the voltage is detected as a carrier signal voltage, the sorting circuit is activated to operate, and
a current load controller configured to receive a sequencing signal and a sorting signal; the current load controller is configured to activate the current load to sequence according to the sequencing signal, and disable the current load when the sequence is completed; the current load controller is configured to activate the current load to draw load according to the sorting signal to generate the disturbance signal.

14. The LED light string as claimed in claim 7, wherein the sequencing circuit is configured to further count the number of times the voltage value changes, and the control device or the LED apparatus is configured to record the number of times the voltage value changes as the sequence code.

15. The LED light string as claimed in claim 7, wherein the control device or the LED apparatus is triggered to record the sequence code as the sequence position of the LED lamp in the LED light string according to the disturbance signal received on a data wire or the disturbance signal received on a resistor.

16. The LED light string as claimed in claim 10, wherein each LED apparatus further comprises:
a signal processing unit connected to a data wire, and the signal processing unit comprising a signal amplifier and a signal processor, and
a current load controller configured to receive a sequencing signal and a sorting signal; the current load controller configured to activate the current load to sequence according to the sequencing signal, and disable the current load when the sequence is completed; the current load controller is configured to activate the current load to draw load according to the sorting signal to generate the disturbance signal.

17. The LED light string as claimed in claim 7, wherein each LED apparatus further comprises:
a signal processing unit connected to a data wire, and the signal processing unit comprising a signal amplifier, a signal processor, a switch, and a logic circuit.

18. The LED light string as claimed in claim 7, wherein each LED apparatus further comprises:
a signal processing unit connected to a data wire, and the signal processing unit comprising a signal amplifier and a signal processor, and
a current source configured to receive a sorting signal, and provide a larger current draw to generate a larger disturbance signal according to the sorting signal.

19. The LED light string as claimed in claim 12, wherein each LED apparatus further comprises:
a sequence code register connected to the comparator, and
a selector connected to the counter, the sequence code register, and the comparator, wherein when a comparison result between the serial number and one of the sequence codes is the same, the comparator is configured to control the sequence code register to receive a replacement signal having a new serial number with smaller number of bits than the sequence code, and store the new serial number.

20. The LED light string as claimed in claim 19, wherein the control device is configured to send a plurality of replacement signals to each of the LED lamps, and each LED lamp has the sequence code and the new serial number; when the comparator of the LED lamp and the sequence code register receive the replacement signals, after the comparator compares the sequence code and the serial number and confirms that the sequence code and the serial number are the same, the comparator is configured to control the sequence code register to store the new serial number to replace the sequence code.

21. The LED light string as claimed in claim 19, wherein when a comparison result between the serial number and one of the sequence codes is the same, after the control device detects the disturbance signal, the control device is configured to immediately send the replacement signal and then sends the next sequence codes.

22. The LED light string as claimed in claim 19, when a comparison result between the serial number and one of the sequence codes is the same, the comparator is configured to control the sequence code register to detect the number of times the disturbance signal and record the replacement signal, and then control the sequence code register to store the new serial number.

23. The LED light string as claimed in claim 7, the control device is configured to provide sequence codes in an incremental manner until at least two instances of a disturbance signal are detected, wherein an increment value is determined based on a difference between the sequence codes respectively corresponding to the first two detected disturbance signals, a new initial value of the sequence codes is generated based on the increment value, and the control device continues to provide the sequence codes based on the new initial value.

24. The LED light string as claimed in claim 7, the control device is configured to provide sequence codes in a decremental manner until at least two instances of the disturbance signal are detected, wherein a decrement value is determined based on a difference between the sequence codes respectively corresponding to the first two detected disturbance signals, a new initial value of the sequence codes is generated based on the decrement value, and the control device continues to provide the sequence codes based on the new initial value.

25. A LED apparatus comprising:
a sequencing circuit configured to generate a serial number and store the serial number upon receiving a DC power source, and
a sorting circuit configured to receive a plurality of sequence codes to the LED apparatus, and compare its own serial number with the plurality of sequence codes,
wherein when a comparison result between the serial number and one of the sequence codes is the same, the LED apparatus generates a disturbance signal.

26. A LED lamp comprising:
two power pins configured to receive an external DC power source,
at least one LED coupled to the two power pins,
a LED apparatus coupled to the two power pins and the at least one LED, and drive the LED, the LED apparatus comprising:
a sequencing circuit configured to generate a serial number and store the serial number upon receiving the DC power source,
a sorting circuit configured to receive a plurality of sequence codes to the LED apparatus, and compare its own serial number with the sequence codes,
wherein when a comparison result of the serial number and one of the sequence codes is the same, the LED apparatus generates a disturbance signal, and
a package configured to package the LED apparatus, the at least one LED, and a part of the two power pins, and the other part of the two power pins is exposed outside the package.
